(19) United States
(12) Patent Application Publication
(10) Pub. No.: US 2026/0297397 A1
(43) Pub. Date: Oct. 1, 2026

(54) ELECTRICALLY CONDUCTIVE RESIN ADHESIVE AGENT AND CURED PRODUCT THEREOF

(71) Applicant: THREEBOND CO., LTD., Tokyo (JP)

(72) Inventors: Kosuke MORIMOTO, Tokyo (JP); Satoru ENDO, Tokyo (JP); Takashi NEMOTO, Tokyo (JP)

(21) Appl. No.: 19/490,989

(22) PCT Filed: May 15, 2024
(86) PCT No.: PCT/JP2024/017896

§ 371 Date: Dec. 8, 2025

(30) Foreign Application Priority Data
Jun. 16, 2023 (JP) 2023-098857

(51) Int. Cl. C09J 9/02; C09J 4/06; C09J 11/04; C09J 163/00; H01B 1/20

(52) U.S. Cl. CPC C09J 9/02; C09J 4/06; C09J 11/04; C09J 163/00; H01B 1/20

(57) ABSTRACT

A conductive resin adhesive agent contains the following components (A)-(D). Component (A) is an epoxy resin having two or more glycidyl groups. Component (B) is a polyfunctional vinyl ether having a ring structure (excluding the epoxy resin having two or more glycidyl groups). Component (C) is conductive particles. Component (D) is a thermal cationic polymerization initiator.

### TECHNICAL FIELD

The present invention relates to an electrically conductive resin adhesive agent that can provide a cured product having excellent adhesive force and electrical conductivity through curing in a short time, and to a cured product thereof.

### BACKGROUND ART

Conventionally, electrically conductive resin adhesive agents have been used for applications such as fixing and grounding of electric and electronic components, including smart phones and electronic mobile devices. In recent years, plastics have been widely used as members in electronic components from the viewpoint of miniaturization and weight reduction. Therefore, the use of adhesive agents requiring heating for a long time has been difficult, because excessive heating causes deformation of the members. In view of this, an electrically conductive resin adhesive agent using cationic polymerization in Japanese Patent Laid-Open No. 2015-160861 is known as a rapidly curable electrically conductive resin adhesive agent that is cured in a short time.

### SUMMARY OF INVENTION

However, rapidly curable electrically conductive resin adhesive agents have had problems in that the cured products are likely to have unevenness, resulting in a decrease in adhesive strength of the cured products, and/or a decrease in electrical conductivity of the cured products. Accordingly, an object of the present invention is to provide an electrically conductive resin adhesive agent that can be cured in a short time and from which a cured product having excellent adhesive force and electrical conductivity is obtained. Another object of the present invention is to provide a cured product of the electrically conductive resin adhesive agent.

The present inventors have discovered, as a result of diligent studies to achieve the above objects, an approach concerning an electrically conductive resin adhesive agent that can be cured in a short time and from which a cured product having excellent adhesive strength and electrical conductivity is obtained, leading to the completion of the present invention.

The gist of the present invention will be described below. One aspect of the present invention, which can achieve at least one of the above objects, relates to the following.
[1] An electrically conductive resin adhesive agent containing the following components (A) to (D): component (A): an epoxy resin having two or more glycidyl groups;
   component (B): a polyfunctional vinyl ether having a cyclic structure (excluding an epoxy resin having two or more glycidyl groups);
   component (C): electrically conductive particles; and
   component (D): a thermal cationic polymerization initiator.

In addition, the present invention encompasses, as non-limiting examples of preferred embodiments, the embodiments [2] to [10] described below:
[2] The electrically conductive resin adhesive agent according to [1], wherein the component (A) contains a bisphenol type epoxy resin;
[3] The electrically conductive resin adhesive agent according to [1] or [2], wherein the component (A) contains a hydrogenated bisphenol type epoxy resin;
[4] The electrically conductive resin adhesive agent according to any of [1] to [3], wherein the component (B) is a polyfunctional vinyl ether having an alicyclic structure;
[5] The electrically conductive resin adhesive agent according to any of [1] to [4], wherein the component (C) contains crystalline electrically conductive particles;
[6] The electrically conductive resin adhesive agent according to any of [1] to [5], wherein a cationic species of the component (D) is a quaternary ammonium cation;
[7] The electrically conductive resin adhesive agent according to any of [1] to [6], wherein the component (B) is cyclohexanedimethanol divinyl ether;
[8] The electrically conductive resin adhesive agent according to any of [1] to [7], wherein a cured product that has been cured by 130° C.×3 minutes (a cured product that has been cured by heating at 130° C. for 3 minutes; a cured product that has been cured and obtained by heating at 130° C. for 3 minutes) has an electrical conductivity of 0.3Ω or less.

Another aspect of the present invention, which can achieve at least one of the above objects, relates to the following.
[9]A cured product formed by curing the electrically conductive resin adhesive agent according to any of [1] to
[8] (a cured product obtained by curing the electrically conductive resin adhesive agent according to any of [1] to [8]).

It should be noted that the present invention is not limited only to the above aspects or embodiments [1] to [9].

### DESCRIPTION OF EMBODIMENTS

The details of the present invention will be described below. It should be noted that the present invention is not limited only to the following embodiments and can be variously modified within the scope of the claims. The embodiments described herein may be combined arbitrarily to form other embodiments.

The expression “X to Y” is herein used in the sense that the numerical values described before and after “to” (X and Y) are included as the lower limit value and the upper limit value, respectively, and means “X or more and Y or less”. The term “(meth)acryl” herein refers to both acryl and methacryl. The term “(meth)acrylate” herein refers to both acrylate and methacrylate. In the present specification, unless otherwise specified, operations and measurements of physical properties, etc. are carried out under conditions of 25° C. and relative humidity of 55% RH.

### <Electrically Conductive Resin Adhesive Agent>

One aspect of the present invention relates to an electrically conductive resin adhesive agent containing the following components (A) to (D):
component (A): an epoxy resin having two or more glycidyl groups;
component (B): a polyfunctional vinyl ether having a cyclic structure (excluding an epoxy resin having two or more glycidyl groups);
component (C): electrically conductive particles; and
component (D): a thermal cationic polymerization initiator.

According to the present aspect, there can be provided an electrically conductive resin adhesive agent that can be cured in a short time and from which a cured product having excellent adhesive force and electrical conductivity is obtained.

The state of the electrically conductive resin adhesive agent according to one embodiment is not particularly limited. The electrically conductive resin adhesive agent according to one embodiment may be either solid or liquid at 25° C. From the viewpoint of easier application to the adherend and superior adhesive strength at the time of curing, it is preferable that the electrically conductive resin adhesive agent is liquid at 25° C.

The term “liquid” herein refers to having a viscosity of 10,000 Pa-s or less, as measured at a shear rate of 10 s⁻¹ using a cone-plate type rotational viscometer in an environment of 25° C. and 55% RH.

Hereinafter, each component constituting the electrically conductive resin adhesive agent according to the present aspect will be described.

### [Component (A)]

The component (A) is an epoxy resin having two or more glycidyl groups. The term “epoxy resin having two or more glycidyl groups” herein refers to a compound having two or more glycidyl groups (that is, a compound having two or more glycidyl groups in one molecule). The component (A) may be either solid or liquid at 25° C. as long as it is a compound having two or more glycidyl groups (a compound having two or more glycidyl groups in one molecule), and its state is not particularly limited. The description of “liquid” is the same as described above. From the viewpoint of excellent workability, it is preferable that the component (A) is liquid at 25° C. The component (A) may also be a combination of a solid epoxy resin having two or more glycidyl groups and a liquid epoxy resin having two or more glycidyl groups. For the component (A), a commercially available product and/or a synthesized product may be used. One type of component (A) may be used singly or two or more types may be used in combination.

The number of glycidyl groups (that is, the number of glycidyl groups in one molecule) in the epoxy resin having two or more glycidyl groups as the component (A) is not particularly limited as long as it is two or more. The number of glycidyl groups in the epoxy resin having two or more glycidyl groups as the component (A) is preferably two or more and six or less, more preferably two or more and four or less, and still more preferably two.

As the component (A), as long as it has two or more glycidyl groups, the type is not particularly limited, and examples thereof include an aromatic epoxy resin, a heterocyclic epoxy resin, an alicyclic epoxy resin, and an aliphatic epoxy resin.

Examples of the component (A) include an aromatic epoxy resin such as a bisphenol type epoxy resin, a novolac type epoxy resin (for example, a phenol novolac type epoxy resin, a cresol novolac type epoxy resin, and the like), and a naphthalene type epoxy resin having four glycidyl groups; a hydrogenated bisphenol type epoxy resin; an alkylene glycol type epoxy resin; a glycidylamine compound; and the like. These may be used singly or in combinations of two or more thereof.

The component (A) preferably contains an aromatic epoxy resin and/or a hydrogenated bisphenol type epoxy resin, more preferably contains a bisphenol type epoxy resin and/or a hydrogenated bisphenol type epoxy resin, and is still more preferably a bisphenol type epoxy resin and/or a hydrogenated bisphenol type epoxy resin. That is, the component (A) preferably contains at least one epoxy resin selected from the group consisting of an aromatic epoxy resin and a hydrogenated bisphenol type epoxy resin, more preferably contains at least one epoxy resin selected from the group consisting of a bisphenol type epoxy resin and a hydrogenated bisphenol type epoxy resin, and is still more preferably at least one epoxy resin selected from the group consisting of a bisphenol type epoxy resin and a hydrogenated bisphenol type epoxy resin. According to an electrically conductive resin adhesive agent according to one embodiment, which contains an aromatic epoxy resin, in particular a bisphenol type epoxy resin, the cured product exhibits superior electrical conductivity through curing in a short time. According to an electrically conductive resin adhesive agent according to one embodiment, which contains a hydrogenated bisphenol type epoxy resin, the cured product exhibits superior adhesive force through curing in a short time. In one embodiment, the component (A) preferably contains an aromatic epoxy resin, more preferably contains a bisphenol type epoxy resin, still more preferably consists only of a bisphenol type epoxy resin, and particularly preferably consists only of a bifunctional bisphenol type epoxy resin. In one embodiment, the component (A) preferably contains a hydrogenated bisphenol type epoxy resin, more preferably consists only of a hydrogenated bisphenol type epoxy resin, and still more preferably consists only of a bifunctional hydrogenated bisphenol type epoxy resin. In one embodiment, the component (A) preferably contains an aromatic epoxy resin and a hydrogenated bisphenol type epoxy resin, more preferably contains a bisphenol type epoxy resin and a hydrogenated bisphenol type epoxy resin, is still more preferably a bisphenol type epoxy resin and a hydrogenated bisphenol type epoxy resin, and is particularly preferably a bifunctional bisphenol type epoxy resin and a bifunctional hydrogenated bisphenol type epoxy resin.

In one embodiment, the proportion of the mass of the aromatic epoxy resin with respect to the total mass of the component (A) is not particularly limited, and it may be 40% by mass or more, may be 50% by mass or more, may be 90% by mass or more, or may be 100% by mass. In the case where two or more types of aromatic epoxy resins are used in combination, the amount of the aromatic epoxy resin refers to their total amount.

In one embodiment, the proportion of the mass of the bisphenol type epoxy resin with respect to the total mass of the component (A) is not particularly limited, and it may be 40% by mass or more, may be 50% by mass or more, may be 90% by mass or more, or may be 100% by mass. In the case where two or more types of bisphenol type epoxy resins are used in combination, the amount of the bisphenol type epoxy resin refers to their total amount.

In one embodiment, the proportion of the mass of the hydrogenated bisphenol type epoxy resin with respect to the total mass of the component (A) is not particularly limited, and it may be 40% by mass or more, may be 50% by mass or more, may be 90% by mass or more, or may be 100% by mass. In the case where two or more types of hydrogenated bisphenol type epoxy resins are used in combination, the amount of the hydrogenated bisphenol type epoxy resin refers to their total amount.

As a general epoxy resin, in addition to a compound having a glycidyl group, an alicyclic epoxy resin can be mentioned. The term “alicyclic epoxy resin” herein refers to a compound having an alicyclic epoxy group, and the term “alicyclic epoxy group” refers to a functional group having a cyclic structure in which an epoxy ring is fused with a saturated hydrocarbon ring. The alicyclic epoxy group is not particularly limited, and examples thereof include a 3,4-epoxycyclohexyl group. In the present specification, an epoxy resin having one or more alicyclic epoxy groups and two or more glycidyl groups is treated as the component (A). On the other hand, an epoxy resin having an alicyclic epoxy group and no glycidyl group, as well as an epoxy resin having an alicyclic epoxy group and only one glycidyl group, is not treated as the component (A). However, from the viewpoint of adhesive force of the cured product, it is preferable that the component (A) is constituted only by a compound having no alicyclic epoxy group and having two or more glycidyl groups (an epoxy resin having no alicyclic epoxy group and having two or more glycidyl groups).

In the present specification, a compound generally used as a silane coupling agent is treated as an optional component, which will be described later. The term “silane coupling agent” herein refers to a compound in which at least one hydrolyzable group (such as an alkoxy group, an aryloxy group) is bonded to a silicon atom, and at least one organic functional group other than the hydrolyzable group is also bonded to the silicon atom. In the present specification, even in the case where a glycidyl group-containing silane coupling agent has two or more glycidyl groups, such a glycidyl group-containing silane coupling agent is not treated as the component (A) but is treated as a silane coupling agent. In the present specification, even in the case where a glycidyl group-containing silane coupling agent has two or more glycidyl groups, such a glycidyl group-containing silane coupling agent is not treated as the epoxy resin having two or more glycidyl groups but is treated as a silane coupling agent. It is preferable that the epoxy resin having two or more glycidyl groups as the component (A) does not have a silicon atom (does not have a silicon atom in the molecule).

The bisphenol type epoxy resin is not particularly limited, as long as it is an epoxy resin having a bisphenol skeleton. Examples of the bisphenol type epoxy resin include a bisphenol A type epoxy resin, a bisphenol F type epoxy resin, a bisphenol S type epoxy resin, a bisphenol AD type epoxy resin, a urethane-modified bisphenol type epoxy resin, a rubber-modified bisphenol type epoxy resin, and a polyoxyalkylene-modified bisphenol type epoxy resin. These may be used singly or in combinations of two or more thereof.

From the viewpoint that the cured product exhibits superior electrical conductivity through curing in a short time, the bisphenol type epoxy resin preferably contains at least one selected from the group consisting of a bisphenol A type epoxy resin, a bisphenol F type epoxy resin, and a polyoxyalkylene-modified bisphenol type epoxy resin, is more preferably at least one selected from the group consisting of a bisphenol A type epoxy resin, a bisphenol F type epoxy resin, and a polyoxyalkylene-modified bisphenol type epoxy resin, is still more preferably at least one selected from the group consisting of a bifunctional bisphenol A type epoxy resin, a bifunctional bisphenol F type epoxy resin, and a bifunctional polyoxyalkylene-modified bisphenol type epoxy resin, and is particularly preferably at least one selected from the group consisting of a bifunctional bisphenol A type epoxy resin, a bifunctional bisphenol F type epoxy resin, and a bifunctional polyoxyalkylene-modified bisphenol A type epoxy resin. In one embodiment, the bisphenol type epoxy resin preferably contains at least one selected from the group consisting of a bisphenol A type epoxy resin and a bisphenol F type epoxy resin, is more preferably at least one selected from the group consisting of a bisphenol A type epoxy resin and a bisphenol F type epoxy resin, is still more preferably at least one selected from the group consisting of a bifunctional bisphenol A type epoxy resin and a bifunctional bisphenol F type epoxy resin, and particularly preferably consists only of a bifunctional bisphenol A type epoxy resin and a bifunctional bisphenol F type epoxy resin. In one embodiment, the bisphenol type epoxy resin may consist only of a polyoxyalkylene-modified bisphenol type epoxy resin, may consist only of a bifunctional polyoxyalkylene-modified bisphenol type epoxy resin, or may consist only of a bifunctional polyoxyalkylene-modified bisphenol A type epoxy resin.

In one embodiment, the proportion of the total mass of the bisphenol A type epoxy resin and the bisphenol F type epoxy resin with respect to the total mass of the bisphenol type epoxy resin is not particularly limited, and it may be 40% by mass or more, may be 50% by mass or more, may be 90% by mass or more, or may be 100% by mass. In the case where two or more types of bisphenol A type epoxy resins are used in combination, the amount of the bisphenol A type epoxy resin refers to their total amount. In the case where two or more types of bisphenol F type epoxy resins are used in combination, the amount of the bisphenol F type epoxy resin refers to their total amount.

For the bisphenol type epoxy resin, a commercially available product and/or a synthesized product may be used. Examples of a commercially available product of the bisphenol type epoxy resin include, but are not particularly limited to, jER (registered trademark, hereinafter the same applies) 828, 1001, 801, 806, 807, and YX4000 (manufactured by Mitsubishi Chemical Corporation); EPICLON (registered trademark, hereinafter the same applies) 830, 850, EXA-830CRP, EXA-830LVP, EXA-850CRP, and EXA-835LV (manufactured by DIC Corporation); Adeka Resin (registered trademark, hereinafter the same applies) EP-4100, EP-4000, EP-4000S, EP-4080, EP-4085, EP-4088, EPU-6, EPU-7N, EPR-4023, EPR-1309, and EP-4920 (manufactured by Adeka Corporation); TEPIC (registered trademark, manufactured by Nissan Chemical Industries, Ltd.); KF-101, KF-1001, KF-105, X-22-163B, and X-22-9002 (manufactured by Shin-Etsu Chemical Co., Ltd.); DENACOL EX411, 314, 201, 212, and 252 (manufactured by Nagase ChemteX Corporation); D.E.R.-331, 332, 334, 431, and 542 (manufactured by Dow Chemical Company); YH-434 and YH-434L (manufactured by Nippon Steel Chemical & Material Co., Ltd.); and the like. These may be used singly or in combinations of two or more thereof.

The term “hydrogenated bisphenol type epoxy resin” herein refers to a compound formed by hydrogenating the aromatic rings of a bisphenol type epoxy resin. The hydrogenated bisphenol type epoxy resin is not particularly limited, as long as it is a compound formed by hydrogenating the aromatic rings of a bisphenol type epoxy resin. Examples of the hydrogenated bisphenol type epoxy resin include a hydrogenated bisphenol A type epoxy resin, a hydrogenated bisphenol F type epoxy resin, a hydrogenated bisphenol E type epoxy resin, and a hydrogenated bisphenol S type epoxy resin. These may be used singly or in combinations of two or more thereof. From the viewpoint that the cured product exhibits superior adhesive force through curing in a short time, the hydrogenated bisphenol type epoxy resin preferably contains at least one selected from the group consisting of a hydrogenated bisphenol A type epoxy resin and a hydrogenated bisphenol F type epoxy resin, more preferably contains a hydrogenated bisphenol A type epoxy resin, still more preferably consists only of a hydrogenated bisphenol A type epoxy resin, and particularly preferably consists only of a bifunctional hydrogenated bisphenol A type epoxy resin.

In one embodiment, the proportion of the mass of the hydrogenated bisphenol A type epoxy resin with respect to the total mass of the hydrogenated bisphenol type epoxy resin is not particularly limited, and it may be 40% by mass or more, may be 50% by mass or more, may be 90% by mass or more, or may be 100% by mass. In the case where two or more types of hydrogenated bisphenol A type epoxy resins are used in combination, the amount of the hydrogenated bisphenol A type epoxy resin refers to their total amount.

For the hydrogenated bisphenol type epoxy resin, a commercially available product and/or a synthesized product may be used. Examples of a commercially available product of the hydrogenated bisphenol type epoxy resin include ST-3000 (manufactured by Nippon Steel Chemical & Material Co., Ltd.); RIKARESIN (registered trademark) HBE-100 (manufactured by New Japan Chemical Co., Ltd.); Epolight 4000 (manufactured by Kyoeisha Chemical Co., Ltd.); jER (registered trademark) YX8000 and YX8034 (manufactured by Mitsubishi Chemical Corporation); and the like, but the commercially available product of the hydrogenated bisphenol type epoxy resin is not limited to these. These may be used singly or in combinations of two or more thereof.

In one embodiment, the proportion of the total mass of the bisphenol A type epoxy resin and the bisphenol F type epoxy resin with respect to the total mass of the component (A) is not particularly limited, and it may be 40% by mass or more, may be 50% by mass or more, may be 90% by mass or more, or may be 100% by mass. In one embodiment, the proportion of the total mass of the bisphenol A type epoxy resin, the bisphenol F type epoxy resin, and the polyoxyalkylene-modified bisphenol type epoxy resin with respect to the total mass of the component (A) is not particularly limited, and from the viewpoint of the electrical conductivity of the cured product, it is preferably more than 50% by mass, more preferably 60% by mass or more, still more preferably 70% by mass or more, even more preferably 80% by mass or more, yet more preferably 90% by mass or more, and particularly preferably 100% by mass. In the case where two or more types of bisphenol A type epoxy resins are used in combination, the amount of the bisphenol A type epoxy resin refers to their total amount.

In the case where two or more types of bisphenol F type epoxy resins are used in combination, the amount of the bisphenol F type epoxy resin refers to their total amount. In the case where two or more types of polyoxyalkylene-modified bisphenol type epoxy resins are used in combination, the amount of the polyoxyalkylene-modified bisphenol type epoxy resin refers to their total amount.

In one embodiment, the proportion of the mass of the hydrogenated bisphenol A type epoxy resin with respect to the total mass of the component (A) is not particularly limited, and from the viewpoint of the adhesive force of the cured product, it is preferably 40% by mass or more, and more preferably 50% by mass or more. The proportion of the mass of the hydrogenated bisphenol A type epoxy resin with respect to the total mass of the component (A) is, from the viewpoints of the adhesive force of the cured product and the electrical conductivity of the cured product, preferably 60% by mass or more, more preferably 70% by mass or more, still more preferably 80% by mass or more, even more preferably 90% by mass or more, and particularly preferably 100% by mass. In the case where two or more types of hydrogenated bisphenol A type epoxy resins are used in combination, the amount of the hydrogenated bisphenol type epoxy resin refers to their total amount.

The epoxy equivalent of the component (A) is not particularly limited, and it is preferably 50 g/eq or more and 500 g/eq or less, more preferably 100 g/eq or more and 400 g/eq or less, and still more preferably 150 g/eq or more and 350 g/eq or less. The epoxy equivalent can be measured in accordance with JIS K 7236:2009.

The viscosity of the component (A) at 25° C. is not particularly limited, and it may be, for example, 1,000 mPa-s or more and 30,000 mPa-s or less, may be 10,000 mPa-s or more and 30,000 mPa-s or less, or may be 1,000 mPa-s or more and less than 10,000 mPa-s. The viscosity at 25° C. refers to a value as measured at a shear rate of 10 s⁻¹ using a cone-plate type rotational viscometer in an environment of 25° C. and 55% RH.

The content of the component (A) is not particularly limited, and examples thereof include 5% by mass or more and 50% by mass or less, 5% by mass or more and 30% by mass or less, and 10% by mass or more and 20% by mass or less, with respect to the total mass of the electrically conductive resin adhesive agent. In the case where two or more types of component (A) are used in combination, the amount of the component (A) refers to their total amount.

### [Component (B)]

The component (B) is a polyfunctional vinyl ether having a cyclic structure. The component (B) may be either solid or liquid at 25° C. as long as it is a compound having a cyclic structure and having two or more vinyl ether (vinyl ether groups) (a compound having a cyclic structure and having two or more vinyl ether (vinyl ether groups) in one molecule), and its state is not particularly limited. The description of “liquid” is the same as described above. From the viewpoint of excellent workability, it is preferable that the component (B) is liquid at 25° C. By having two or more vinyl ether, it is possible to obtain a cured product having excellent electrical conductivity through curing in a short time. One type of component (B) may be used singly or two or more types may be used in combination.

In the present specification, the polyfunctional vinyl ether having a cyclic structure as the component (B) excludes an epoxy resin having two or more glycidyl groups. In the present specification, a compound which falls within the scope of the compound of the epoxy resin having two or more glycidyl groups as the component (A) and also falls within the scope of the compound of the polyfunctional vinyl ether having a cyclic structure as the component (B) is treated as the component (A). That is, in the present specification, a polyfunctional vinyl ether having two or more glycidyl groups and having a cyclic structure is treated as the component (A). It is preferable that the polyfunctional vinyl ether having a cyclic structure as the component (B) has no glycidyl group.

In the present specification, a compound generally used as a silane coupling agent is treated as an optional component, which will be described later. That is, in the present specification, even in the case where a vinyl group-containing silane coupling agent has a cyclic structure and has two or more vinyl ether groups, such a vinyl group-containing silane coupling agent is not treated as the component (B) but is treated as a silane coupling agent. It is preferable that the polyfunctional vinyl ether having a cyclic structure as the component (B) does not have silicon.

In the polyfunctional vinyl ether having a cyclic structure as the component (B), the number of vinyl ether (the number of vinyl ether groups in one molecule) is not particularly limited as long as it is two or more. The number of vinyl ether in the polyfunctional vinyl ether having a cyclic structure as the component (B) is preferably two or more and six or less, more preferably two or more and four or less, and still more preferably two.

Examples of the cyclic structure of the component (B) include an alicyclic structure, an aromatic ring structure, and a heterocyclic structure. From the viewpoints of the adhesive force of the cured product and the electrical conductivity of the cured product through curing in a short time, the cyclic structure is preferably an alicyclic structure or an aromatic ring structure, and more preferably an alicyclic structure. The term “alicyclic” refers to a saturated or unsaturated carbon ring other than an aromatic ring. The alicyclic structure is preferably a cycloalkane ring, more preferably a cycloalkane ring having 3 to 8 carbon atoms, and still more preferably a cyclohexane ring. From the viewpoint of miscibility with the component (A), it is preferable that the component (B) is liquid at 25° C.

In one embodiment, the component (B) is preferably a polyfunctional vinyl ether having at least one structure selected from the group consisting of an alicyclic structure, an aromatic ring structure, and a heterocyclic structure; more preferably a polyfunctional vinyl ether having at least one structure selected from the group consisting of an alicyclic structure and an aromatic ring structure; still more preferably a polyfunctional vinyl ether having an alicyclic structure; even more preferably a polyfunctional vinyl ether having only an alicyclic structure as the cyclic structure; yet more preferably a polyfunctional vinyl ether having only a cycloalkane ring as the cyclic structure; further preferably a polyfunctional vinyl ether having only a cycloalkane ring having 3 to 8 carbon atoms as the cyclic structure; and particularly preferably a polyfunctional vinyl ether having only a cyclohexane ring as the cyclic structure.

From the viewpoint of the electrical conductivity of the cured product, it is preferable that the electrically conductive resin adhesive agent according to one embodiment does not contain a monofunctional vinyl ether.

Specific examples of the component (B) include, but are not particularly limited to, cyclohexanedimethanol divinyl ether and a bisphenol type divinyl ether. Examples of the bisphenol type divinyl ether include, but are not particularly limited to, a bisphenol A type divinyl ether and a bisphenol F type divinyl ether. These may be used singly or in combinations of two or more thereof. The component (B) preferably contains at least one compound selected from the group consisting of cyclohexanedimethanol divinyl ether and a bisphenol type divinyl ether, more preferably contains at least one compound selected from the group consisting of cyclohexanedimethanol divinyl ether, a bisphenol A type divinyl ether, and a bisphenol F type divinyl ether, still more preferably contains cyclohexanedimethanol divinyl ether, and is particularly preferably cyclohexanedimethanol divinyl ether.

For the component (B), a commercially available product and/or a synthesized product may be used. Examples of a commercially available product of the component (B) include, but are not particularly limited to, CHDVE (manufactured by Nippon Carbide Industries Co., Inc.).

The content of the component (B) is not particularly limited, and it is preferably 10 to 150 parts by mass, more preferably 15 to 100 parts by mass, and still more preferably 20 to 60 parts by mass, with respect to 100 parts by mass of the component (A). When the content of the component (B) is 10 parts by mass or more with respect to 100 parts by mass of the component (A), it is possible to obtain an electrically conductive resin adhesive agent having superior curability through curing in a short time and electrical conductivity of the cured product. When the content of the component (B) is 150 parts by mass or less with respect to 100 parts by mass of the component (A), it is possible to obtain an electrically conductive resin adhesive agent from which a cured product having superior adhesive force is obtained through curing in a short time. In the case where two or more types of component (A) are used in combination, the amount of the component (A) refers to their total amount. In the case where two or more types of component (B) are used in combination, the amount of the component (B) refers to their total amount.

### [Component (C)]

The component (C) is electrically conductive particles. The component (C) is not particularly limited in terms of particle material or particle shape as long as it exhibits electrical conductivity. For the component (C), a synthesized product and/or a commercially available product may be used. One type of component (C) may be used singly or two or more types may be used in combination.

Examples of the component (C) include, but are not particularly limited to, metal particles constituted by a single metal selected from gold, silver, copper, nickel, palladium, platinum, tin, bismuth, and the like; alloy particles formed by combining multiple types of these metals; and particles in which the surface thereof is coated with one or more of these metals as a coating layer. The component (C) can be, for example, selected from these particles as appropriate. These particles may be used singly or in combinations of two or more thereof. From the viewpoints of the electrical conductivity of the cured product and/or cost and other factors, the component (C) is preferably silver particles or particles formed by coating the surface (that is, the surface of particles to be coated) with silver as a coating layer, and is particularly preferably silver particles. The component (C) preferably contains at least one particles selected from the group consisting of metal particles constituted by a single metal selected from the group consisting of gold, silver, copper, nickel, palladium, platinum, tin, and bismuth metals, alloy particles formed by combining multiple types of these metals, and particles formed by coating the surface of particles to be coated with one or more of these metals as a coating layer; more preferably contains at least one particles selected from the group consisting of metal particles constituted by a single metal selected from the group consisting of gold, silver, copper, nickel, palladium, platinum, tin, and bismuth metals, and particles formed by coating the surface of particles to be coated with one or more of these metals as a coating layer; still more preferably contains at least one particles selected from the group consisting of silver particles and particles formed by coating the surface of particles to be coated with silver as a coating layer; is even more preferably at least one particles selected from the group consisting of silver particles and particles formed by coating the surface of particles to be coated with silver as a coating layer; and is particularly preferably silver particles.

Examples of the shape of the component (C) include, but are not particularly limited to, spherical, irregular, flake-like, filamentous (needle-like), and dendritic shapes. As the flake-like shape, a plate-like (plate-like) shape, as will be described later, is preferable. Particles having these shapes may be used singly or in combinations of two or more thereof. In one embodiment, the component (C) preferably contains particles having at least one shape selected from the group consisting of spherical particles, irregular particles, flake-like particles (such as plate-like particles), filamentous particles, and dendritic particles; more preferably contains flake-like particles; still more preferably contains plate-like particles; and is particularly preferably plate-like particles.

The component (C) may be surface-treated. For example, the component (C) may be surface-treated with a lubricant. Therefore, the electrically conductive particles as the component (C) may be electrically conductive particles that have been surface-treated with a lubricant. The lubricant is not particularly limited, and for example, a saturated fatty acid and/or an unsaturated fatty acid can be used. Examples of the saturated fatty acid or the unsaturated fatty acid include, but are not particularly limited to, capric acid, undecylic acid, lauric acid, tridecylic acid, myristic acid, pentadecylic acid, palmitic acid, margaric acid, stearic acid, linolenic acid, linoleic acid, palmitoleic acid, oleic acid, malonic acid, and hexanoic acid. These may be used singly or in combinations of two or more thereof. However, from the viewpoint that the cured product exhibits superior adhesive force and/or electrical conductivity through curing in a short time, the component (C) is preferably untreated (that is, electrically conductive particles that have not been surface-treated with a lubricant). In one embodiment, the component (C) preferably contains electrically conductive particles that have not been surface-treated with a lubricant, and is more preferably electrically conductive particles that have not been surface-treated with a lubricant. In one embodiment, the component (C) preferably contains electrically conductive particles that have not been surface-treated, and is more preferably electrically conductive particles that have not been surface-treated. In one embodiment, the component (C) preferably contains silver particles that have not been surface-treated, and is more preferably silver particles that have not been surface-treated. As the component (C), for example, particles that have been surface-treated with a lubricant, particles that have not been surface-treated with a lubricant, or particles that have not been surface-treated may be used singly, and for example, two or more types of particles selected from the group consisting of particles that have been surface-treated with a lubricant, particles that have not been surface-treated with a lubricant, and particles that have not been surface-treated may be used in combination.

The component (C) preferably contains crystalline electrically conductive particles, and is more preferably crystalline electrically conductive particles. The method for producing the crystalline electrically conductive particles is not particularly limited. The crystalline electrically conductive particles may be produced by a known production method, and examples of the method for producing the crystalline electrically conductive particles include a production method in which electrically conductive particles are produced by growing a single crystal, generally called a reduction method, as shown in Japanese Patent Laid-Open No. 2014-196527 (corresponding to U.S. Patent Application Publication No. 2016/001362). Examples of the shape of the crystalline electrically conductive particle include, but are not particularly limited to, spherical, irregular, flake-like, filamentous (needle-like), and dendritic shapes, as described above for the shape of the electrically conductive particle.

In the present specification, the flake-like shape refers to a flattened shape, and is treated as encompassing shapes such as a scale-like shape and a plate-like (plate-like) shape, as will be described below. In the present specification, a polygonal plate-like shape in which the thickness of the entire flake (the entire flake-like shape) is substantially the same and the surface is generally smooth is also referred to as a plate-like (plate-like) shape. The crystalline electrically conductive particle is preferably particle having a polygonal plate-like shape in which the thickness of the entire flake (the entire flake-like shape) is substantially the same and the surface is generally smooth. That is, the crystalline electrically conductive particle is preferably a plate-like (plate-like) particle. Examples of the polygonal plate-like shape include, but are not particularly limited to, a triangular plate shape, a quadrangular plate shape, a pentagonal plate shape, and a hexagonal plate shape.

In one embodiment, the crystalline electrically conductive particles preferably contain flake-like crystalline electrically conductive particles, more preferably contain plate-like crystalline electrically conductive particles, and are still more preferably plate-like crystalline electrically conductive particles. From the viewpoint that the cured product exhibits superior electrical conductivity through curing in a short time, it is preferable that the crystalline electrically conductive particles are crystalline silver particles. In one embodiment, the component (C) preferably contains crystalline silver particles, is more preferably crystalline silver particles, is still more preferably flake-like crystalline silver particles, is even more preferably plate-like crystalline silver particles, and is particularly preferably plate-like crystalline silver particles that have not been surface-treated. Whether the electrically conductive particles as the component (C) are crystalline particles can be determined by, for example, observation of the shape using a scanning electron microscope (SEM).

For the crystalline electrically conductive particles, a commercially available product and/or a synthesized product may be used. Examples of a commercially available product of the crystalline electrically conductive particles include, but are not particularly limited to, N300, M612, M13, M27, and LM1 (manufactured by Tokusen Kogyo Co., Ltd.).

As the component (C), crystalline electrically conductive particles and non-crystalline electrically conductive particles may be used in combination. In the case where crystalline electrically conductive particles and non-crystalline electrically conductive particles are used in combination, the weight ratio (mass ratio) of the crystalline electrically conductive particles to the non-crystalline electrically conductive particles is preferably the crystalline electrically conductive particles:the non-crystalline electrically conductive particles=10:90 to 90:10, more preferably the crystalline electrically conductive particles:the non-crystalline electrically conductive particles=10:90 to 75:25, and still more preferably the crystalline electrically conductive particles:the non-crystalline electrically conductive particles=15:85 to 50:50. When the weight ratio is in the above range, it is possible to obtain an electrically conductive resin adhesive agent from which a cured product having superior electrical conductivity is obtained through curing in a short time. In the case where two or more types of crystalline electrically conductive particles are used in combination, the amount of the crystalline electrically conductive particles refers to their total amount. In the case where two or more types of non-crystalline electrically conductive particles are used in combination, the amount of the non-crystalline electrically conductive particles refers to their total amount.

Examples of the shape of the non-crystalline electrically conductive particle include, but are not particularly limited to, spherical, irregular, flake-like (such as scale-like), filamentous (needle-like), and dendritic shapes, as described above for the shape of the electrically conductive particle. Non-crystalline electrically conductive particles having these shapes may be used singly or in combinations of two or more thereof. From the viewpoint of superior electrical conductivity, the non-crystalline electrically conductive particles preferably contain flake-like or spherical non-crystalline electrically conductive particles. Examples of the non-crystalline electrically conductive particles include, but are not particularly limited to, flake-like electrically conductive particles obtained by a pulverization step, and electrically conductive particles in which the surface of organic particles or inorganic particles is coated with an electrically conductive metal. From the viewpoint that the cured product exhibits superior electrical conductivity through curing in a short time, it is preferable that the non-crystalline electrically conductive particles are silver particles or particles formed by coating the surface of particles to be coated with silver as a coating layer.

The average particle diameter of the component (C) is not particularly limited, and is preferably in the range of 0.01 to 100 μm, more preferably in the range of 0.1 to 50 μm, still more preferably 0.1 to 30 μm, and particularly preferably 0.3 to 10 μm. Here, the average particle diameter of the component (C) refers to the particle diameter (D50) at a cumulative volume ratio of 50% in a particle size distribution determined by a laser diffraction/scattering method. In the case where the component (C) contains two or more types of electrically conductive particles, the above average particle diameter refers to the average particle diameter of the individual electrically conductive particles. From the viewpoint of superior electrical conductivity, the average particle diameter of the crystalline electrically conductive particles is preferably in the range of 0.01 to 100 μm, more preferably in the range of 0.1 to 50 μm, still more preferably in the range of 0.01 to 30 μm, even more preferably in the range of 0.1 to 20 μm, and particularly preferably in the range of 0.3 to 10 μm. Here, the average particle diameter of the crystalline electrically conductive particles refers to the particle diameter (D50) at a cumulative volume ratio of 50% in a particle size distribution determined by a laser diffraction/scattering method. In the case where the component (C) contains two or more types of crystalline electrically conductive particles, the above average particle diameter refers to the average particle diameter of the individual crystalline electrically conductive particles. The average particle diameter of the non-crystalline electrically conductive particles is preferably in the range of 0.1 to 50 μm, more preferably in the range of 0.1 to 30 μm, still more preferably 1 to 20 μm, and particularly preferably 1 to 15 μm. The average particle diameter of the non-crystalline electrically conductive particles refers to the particle diameter (D50) at a cumulative volume ratio of 50% in a particle size distribution determined by a laser diffraction/scattering method. In the case where the component (C) contains two or more types of non-crystalline electrically conductive particles, the above average particle diameter refers to the average particle diameter of the individual non-crystalline electrically conductive particles.

The content of the component (C) is not particularly limited, and it is preferably 200 to 1000 parts by mass, more preferably 300 to 800 parts by mass, and still more preferably 350 to 700 parts by mass, with respect to 100 parts by mass of the component (A). When the content of the component (C) is 200 parts by mass or more with respect to 100 parts by mass of the component (A), it is possible to obtain an electrically conductive resin adhesive agent from which a cured product having superior electrical conductivity is obtained through curing in a short time. When the content of the component (C) is 1000 parts by mass or less with respect to 100 parts by mass of the component (A), it is possible to obtain an electrically conductive resin adhesive agent having excellent workability. In the case where two or more types of component (A) are used in combination, the amount of the component (A) refers to their total amount. In the case where two or more types of component (C) are used in combination, the amount of the component (C) refers to their total amount.

The content of the component (C) is not particularly limited, and it is preferably 40 to 95% by mass, more preferably 50 to 90% by mass, and still more preferably 60 to 85% by mass, with respect to the entire electrically conductive resin adhesive agent. When the content is in the above range, it is possible to obtain an electrically conductive resin adhesive agent that exhibits excellent workability and superior electrical conductivity of the cured product through curing in a short time. In the case where two or more types of component (C) are used in combination, the amount of the component (C) refers to their total amount.

### [Component (D)]

The component (D) is a thermal cationic polymerization initiator. The thermal cationic polymerization initiator is a compound that generates a cationic species by heating. One type of component (D) may be used singly or two or more types may be used in combination.

The component (D) is not particularly limited, and examples thereof include a thermal cationic polymerization initiator containing a salt composed of a hexafluoroantimonate anion and a cation, a thermal cationic polymerization initiator containing a salt composed of a hexafluorophosphate anion and a cation, a thermal cationic polymerization initiator containing a salt composed of a tetrakis(pentafluorophenyl)borate anion and a cation, and a boron trifluoride derivative. Among these, from the viewpoint that it is possible to obtain an electrically conductive resin adhesive agent that exhibits less warpage at the time of adhesion to dissimilar materials and superior adhesive force of the cured product, a thermal cationic polymerization initiator containing a salt composed of a tetrakis(pentafluorophenyl)borate anion and a cation, and a boron trifluoride derivative are preferable, and a thermal cationic polymerization initiator containing a salt composed of a tetrakis(pentafluorophenyl)borate anion and a cation is more preferable. These may be used singly or in combinations of two or more thereof. The component (D) preferably contains at least one thermal cationic polymerization initiator selected from the group consisting of a thermal cationic polymerization initiator containing a salt composed of a hexafluoroantimonate anion and a cation, a thermal cationic polymerization initiator containing a salt composed of a hexafluorophosphate anion and a cation, a thermal cationic polymerization initiator containing a salt composed of a tetrakis(pentafluorophenyl)borate anion and a cation, and a boron trifluoride derivative; more preferably contains at least one thermal cationic polymerization initiator selected from the group consisting of a thermal cationic polymerization initiator containing a salt composed of a tetrakis(pentafluorophenyl)borate anion and a cation, and a boron trifluoride derivative; still more preferably contains a thermal cationic polymerization initiator containing a salt composed of a tetrakis(pentafluorophenyl)borate anion and a cation; and is particularly preferably a thermal cationic polymerization initiator containing a salt composed of a tetrakis(pentafluorophenyl)borate anion and a cation. The cation is not particularly limited, and examples thereof include a quaternary ammonium cation and a sulfonium ion in which at least one of the three groups bonded to the sulfur atom is an alkyl group having 1 to 8 carbon atoms, and a quaternary ammonium cation is preferable. These may be used singly or in combinations of two or more thereof. The cation contained in the thermal cationic polymerization initiator as the component (D) (also referred to herein as the cationic species of the component (D)) preferably contains at least one cation selected from the group consisting of a quaternary ammonium cation and a sulfonium ion in which at least one of the three groups bonded to the sulfur atom is an alkyl group having 1 to 8 carbon atoms; more preferably contains a quaternary ammonium cation; and is still more preferably a quaternary ammonium cation.

Preferred examples of the thermal cationic polymerization initiator containing a salt composed of a tetrakis(pentafluorophenyl)borate anion and a cation include a thermal cationic polymerization initiator containing a salt composed of a tetrakis(pentafluorophenyl)borate anion and a quaternary ammonium cation, from the viewpoint that it is possible to obtain an electrically conductive resin adhesive agent that exhibits less warpage at the time of adhesion to dissimilar materials and superior adhesive force of the cured product through curing in a short time. The boron trifluoride derivative is not particularly limited, and examples thereof include boron trifluoride monomethylamine, boron trifluoride monoethylamine (boron 3-fluoride monoethylamine), and boron trifluoride monopropylamine. These may be used singly or in combinations of two or more thereof. The component (D) preferably contains at least one selected from the group consisting of a thermal cationic polymerization initiator containing a salt composed of a tetrakis(pentafluorophenyl)borate anion and a quaternary ammonium cation, boron trifluoride monomethylamine, boron trifluoride monoethylamine (boron 3-fluoride monoethylamine), and boron trifluoride monopropylamine; more preferably contains a thermal cationic polymerization initiator containing a salt composed of a tetrakis(pentafluorophenyl)borate anion and a quaternary ammonium cation; and is still more preferably a thermal cationic polymerization initiator containing a salt composed of a tetrakis(pentafluorophenyl)borate anion and a quaternary ammonium cation.

For the component (D), a commercially available product and/or a synthesized product may be used. Examples of a commercially available product of the thermal cationic polymerization initiator containing a salt composed of a hexafluoroantimonate anion and a cation include, but are not particularly limited to, SI-60L, SI-80L, and SI-100L manufactured by Sanshin Chemical Industry Co., Ltd. In addition, examples of a commercially available product of the thermal cationic polymerization initiator containing a salt composed of a hexafluorophosphate anion and a cation include, but are not particularly limited to, SI-110L, SI-180L, SI-B2A, and SI-B3A manufactured by Sanshin Chemical Industry Co., Ltd. Then, examples of a commercially available product of the thermal cationic polymerization initiator containing a salt composed of a tetrakis(pentafluorophenyl)borate anion and a cation include, but are not particularly limited to, K-PURE (registered trademark) CXC-1821 manufactured by King Industries, Inc. Furthermore, examples of a commercially available product of the boron trifluoride derivative include, but are not particularly limited to, boron trifluoride monoethylamine manufactured by Stella Chemifa Corporation. These may be used singly or in combinations of two or more thereof.

The content of the component (D) is not particularly limited, and it is preferably 1 to 30 parts by mass, more preferably 5 to 25 parts by mass, and still more preferably 10 to 20 parts by mass, with respect to 100 parts by mass of the component (A). The content of the component (D) being 1 part by mass or more with respect to 100 parts by mass of the component (A) results in superior curability in a short time. When the content of the component (D) is 30 parts by mass or less with respect to 100 parts by mass of the component (A), it is possible to obtain an electrically conductive resin adhesive agent from which a cured product having superior electrical conductivity is obtained through curing in a short time. In the case where two or more types of component (A) are used in combination, the amount of the component (A) refers to their total amount. In the case where two or more types of component (D) are used in combination, the amount of the component (D) refers to their total amount.

### [Optional Component]

To the electrically conductive resin adhesive agent according to the present aspect, in addition to the above components, various additives can be added as an optional component, as necessary, to the extent that the effects of the present invention are not impaired. That is, the electrically conductive resin adhesive agent according to the present aspect may contain an optional component in addition to the above components, or may not contain an optional component in addition to the above components. Examples of the additive as an optional component may include, but are not particularly limited to, a monofunctional reactive diluent, a silane coupling agent, a plasticizer, a filler (excluding electrically conductive particles), a storage stabilizer, a tackifier, a metal complex, an organic pigment, an inorganic pigment, a rust inhibitor, a defoaming agent, a dispersant, a surfactant, a viscoelasticity modifier, a thickener, and a radical polymerizable compound (excluding both a polyfunctional vinyl ether having a cyclic structure and a silane coupling agent).

### (Monofunctional Reactive Diluent)

The electrically conductive resin adhesive agent according to the present aspect may further contain a monofunctional reactive diluent, or may not further contain a monofunctional reactive diluent. The monofunctional reactive diluent is an epoxy resin having one glycidyl group. That is, the monofunctional reactive diluent is a compound having one glycidyl group. The monofunctional reactive diluent differs from the component (A) in that it has only one glycidyl group.

In the present specification, a compound having one glycidyl group and also included in the component (B) is treated as the component (B). That is, in the present specification, a polyfunctional vinyl ether having one glycidyl group and a cyclic structure is treated as the component (B).

In the present specification, even in the case where a glycidyl group-containing silane coupling agent has one glycidyl group, such a glycidyl group-containing silane coupling agent is not treated as the monofunctional reactive diluent but is treated as a silane coupling agent.

Although when the electrically conductive resin adhesive agent according to one embodiment contains a monofunctional reactive diluent, it is possible to obtain an electrically conductive resin adhesive agent having excellent workability, since the generation of outgas easily occurs, it is preferable that the electrically conductive resin adhesive agent according to one embodiment is substantially free from the monofunctional reactive diluent, and more preferably free from the monofunctional reactive diluent. The content of the reactive diluent is not particularly limited, and for example, it is preferably 10% by mass or less, more preferably 1% by mass or less, still more preferably 0.1% by mass or less, and particularly preferably 0% by mass, with respect to the entire electrically conductive resin adhesive agent. The expression “the electrically conductive resin adhesive agent being substantially free from the reactive diluent” herein means that the content of the reactive diluent is 0.1% by mass or less with respect to the entire electrically conductive resin adhesive agent. The expression “the electrically conductive resin adhesive agent being free from the reactive diluent” herein means that the content of the reactive diluent is 0% by mass with respect to the entire electrically conductive resin adhesive agent. In the case where two or more types of monofunctional reactive diluents are used in combination, the amount of the monofunctional reactive diluent refers to their total amount.

Examples of the monofunctional reactive diluent include, but are not particularly limited to, a glycidyl ether such as methyl glycidyl ether, ethyl glycidyl ether, butyl glycidyl ether, isobutyl glycidyl ether, phenyl glycidyl ether, 2-ethylhexyl glycidyl ether, decyl glycidyl ether, stearyl glycidyl ether, allyl glycidyl ether, 2-methyloctyl glycidyl ether, methoxy polyethylene glycol monoglycidyl ether, ethoxy polyethylene glycol monoglycidyl ether, butoxy polyethylene glycol monoglycidyl ether, phenoxy polyethylene glycol monoglycidyl ether, p-tert-butylphenyl glycidyl ether, sec-butylphenyl glycidyl ether, n-butylphenyl glycidyl ether, phenyl phenol glycidyl ether, cresyl glycidyl ether, and dibromocresyl glycidyl ether; a glycidyl ester such as neodecanoic acid glycidyl ester; and the like. These may be used singly or in combinations of two or more thereof.

### (Silane Coupling Agent)

The electrically conductive resin adhesive agent according to the present aspect may further contain a silane coupling agent, or may not further contain a silane coupling agent. Examples of the silane coupling agent include, but are not particularly limited to, a glycidyl group-containing silane coupling agent such as 3-glycidoxypropyltriethoxysilane, 3-glycidoxypropylmethyldimethoxysilane, 3-glycidoxypropyltrimethoxysilane, and 3-glycidoxypropylmethyldiethoxysilane; a vinyl group-containing silane coupling agent such as vinyltris(β-methoxyethoxy)silane, vinyltriethoxysilane, and vinyltrimethoxysilane; a (meth)acryl group-containing silane coupling agent (acryloyl group- and/or methacryloyl group-containing silane coupling agent) such as γ-methacryloxypropyltrimethoxysilane; an amino group-containing silane coupling agent such as N-β-(aminoethyl)-γ-aminopropyltrimethoxysilane, γ-aminopropyltriethoxysilane, and N-phenyl-γ-aminopropyltrimethoxysilane; γ-mercaptopropyltrimethoxysilane; γ-chloropropyltrimethoxysilane; and oligomers thereof. Among these, a glycidyl group-containing silane coupling agent is preferable from the viewpoint of excellent adhesiveness. These may be used singly or in combinations of two or more thereof.

In the present specification, a glycidyl group-containing silane coupling agent is not treated as the component (A) or as the monofunctional reactive diluent but is treated as a silane coupling agent. Therefore, in the present specification, even in the case where a glycidyl group-containing silane coupling agent has one glycidyl group, such a glycidyl group-containing silane coupling agent is not treated as the monofunctional reactive diluent but is treated as a silane coupling agent. Also, in the present specification, even in the case where a glycidyl group-containing silane coupling agent has two or more glycidyl groups, such a glycidyl group-containing silane coupling agent is not treated as the component (A) but is treated as a silane coupling agent. In the present specification, even in the case where a glycidyl group-containing silane coupling agent has two or more glycidyl groups, such a glycidyl group-containing silane coupling agent is not treated as the epoxy resin having two or more glycidyl groups but is treated as a silane coupling agent.

In the present specification, a vinyl group-containing silane coupling agent is not treated as the component (B) but is treated as a silane coupling agent. That is, in the present specification, even in the case where a vinyl group-containing silane coupling agent has a cyclic structure and has two or more vinyl ether groups, such a vinyl group-containing silane coupling agent is not treated as the component (B) but is treated as a silane coupling agent.

In the present specification, a silane coupling agent having a radical polymerizable functional group is not treated as a radical polymerizable compound, which will be described later, but is treated as a silane coupling agent.

Examples of a commercially available product of the silane coupling agent include, but are not particularly limited to, KBM-1003, KBE-1003, KBM-303, KBM-403, KBE-403, KBM-502, KBE-502, KBM-503, KBE-503, KBM-5103, KBM-1403, KBM-602, KBM-603, KBM-903, and KBE-903 (manufactured by Shin-Etsu Chemical Co., Ltd.); DOWSIL Z-6610, DOWSIL Z-6044, DOWSIL Z-6825, DOWSIL Z-6033, and DOWSIL Z-6062 (manufactured by Dow Toray Co., Ltd.); and the like.

### (Filler)

The electrically conductive resin adhesive agent according to the present aspect may further contain a filler, or may not further contain a filler. The term “filler” herein refers to a filler excluding electrically conductive particles (that is, a filler other than electrically conductive particles). Examples of the filler include, but are not particularly limited to, glass, silica, talc, mica, ceramics, calcium carbonate, carbon powder, kaolin clay, a dried clay mineral, dried diatomaceous earth, and rubber particles. From the viewpoint that the influence on the conductivity of the cured product due to the addition of the filler is smaller, the filler is preferably rubber particles.

The term “rubber particle” herein refers to a particle containing a layer exhibiting rubber elasticity. The rubber particle may be a particle composed only of a single layer exhibiting rubber elasticity, or may be a core-shell particle that is a particle having a multilayer structure exhibiting rubber elasticity. Although the reason is unknown, from the viewpoint of excellent resin resistance (also referred to as volume resistivity), the rubber particles are preferably core-shell particles. It is also possible to use rubber particles that have been dispersed in advance in an epoxy resin. The rubber constituting the rubber particles is not particularly limited, and for example, butadiene rubber, acrylic rubber, silicone rubber, butyl rubber, olefin rubber, styrene rubber, NBR, SBR, IR, EPR, and the like are used. These may be used singly or in combinations of two or more thereof.

The term “core-shell particle” herein refers to a particle in which the core (nucleus) portion and the shell (wall) portion of the particle are composed of polymers having different properties. In the method for producing preferred powder particles, the core portion is first produced by polymerizing a polymerizable monomer. Examples of the polymerizable monomer used for forming the core portion include, but are not particularly limited to, a (meth)acrylate-based monomer such as n-propyl (meth)acrylate, n-butyl (meth)acrylate, 2-ethylhexyl (meth)acrylate, n-decyl (meth)acrylate, 2-hydroxyethyl (meth)acrylate, 3-hydroxybutyl (meth)acrylate, and butoxyethyl (meth)acrylate; an aromatic vinyl-based compound such as styrene, vinyltoluene, and α-methylstyrene; a vinyl cyanide compound such as acrylonitrile and methacrylonitrile; vinylidene cyanide; 2-hydroxyethyl fumarate; hydroxybutyl vinyl ether; monobutyl maleate; and the like. In addition, examples of the polymerizable monomer used for forming the core portion include a crosslinkable monomer having two or more reactive groups such as ethylene glycol di(meth)acrylate, butylene glycol di(meth)acrylate, trimethylolpropane di(meth)acrylate trimethylolpropane tri(meth)acrylate, hexanediol di(meth)acrylate, hexanediol tri(meth)acrylate, oligoethylene di(meth)acrylate, and oligoethylene tri(meth)acrylate; an aromatic divinyl monomer such as divinylbenzene; triallyl trimellitate; triallyl isocyanurate; and the like. One of these or a combination of two or more different types thereof can be selected and used. Next, the polymer particle obtained as described above is used as the core, and a second polymerization is carried out in which a polymerizable monomer is further polymerized to form a shell composed of a polymer having a melting point of room temperature or higher. The polymerizable monomer used at this time (the polymerizable monomer used for forming the shell) is not particularly limited, and for example, one of those that are the same as the above-described polymerizable monomers used for obtaining the core or two or more different types thereof can be selected and used. Preferred examples of the polymerizable monomer used as the shell material include an alkyl (meth)acrylate in which the alkyl group has 1 to 4 carbon atoms, such as ethyl (meth)acrylate, n-butyl acrylate, methyl methacrylate, and butyl methacrylate.

The core-shell particles may be synthesized by the above-described production method, but a commercially available product may be used. As a commercially available product of the core-shell particles, although not particularly limited, for example, the following can be used: Paraloid EXL-2655 (manufactured by Kureha Corporation), which is composed of a butadiene-alkyl methacrylate-styrene copolymerized product; Stafyroid (registered trademark, hereinafter the same applies) AC-3355, Stafyroid AC3364, Stafyroid TR-2105, Stafyroid TR-2102, Stafyroid TR-2122, Stafyroid IM-101, Stafyroid IM-203, Stafyroid IM-301, Stafyroid IM-401, and Stafyroid IM-406, which are composed of acrylic acid ester-methacrylic acid ester copolymers; Stafyroid IM-601, which is composed of an acrylic acid ester-acrylonitrile-styrene copolymer; Zefiac F-351G (manufactured by Aica Kogyo Co., Ltd.), Paraloid EXL-2314, EXL-2611, and EXL-3387 (manufactured by Dow Chemical Japan Ltd.), which are composed of polymethacrylic acid ester-based polymers; and the like. These may be used singly or in combinations of two or more thereof.

As the core-shell particles, for example, (meth)acrylic core-shell particles constituted by an acrylic acid ester-methacrylic acid ester (co)polymer and/or a polymethacrylic acid ester (co)polymer are preferable, since they are effective even when added in a small amount. The term “(co)polymer” is herein a generic term including both copolymer and homopolymer.

Specific examples of the rubber particles that have been dispersed in advance in an epoxy resin include rubber particles dispersed in an epoxy resin by a mixing and stirring apparatus such as Hyper or homogenizer, and rubber particles synthesized by emulsion polymerization in an epoxy resin. These may be used singly or in combinations of two or more thereof. If the epoxy resin in which the rubber particles are dispersed is an epoxy resin having two or more glycidyl groups, such an epoxy resin is treated as the component (A). If the epoxy resin in which the rubber particles are dispersed is an epoxy resin having one glycidyl group, such an epoxy resin is treated as the monofunctional reactive diluent. However, in the case where the epoxy resin in which the rubber particles are dispersed is a silane coupling agent, such an epoxy resin is treated as a silane coupling agent.

Examples of a commercially available product of the rubber-dispersed epoxy resin include, but are not particularly limited to, KaneAce (registered trademark) MX-153, MX-136, MX-257, MX-127, and MX-451 (manufactured by Kaneka Corporation); Acryset (registered trademark) BPF-307 and BPA-328 (manufactured by Nippon Shokubai Co., Ltd.); and the like. These may be used singly or in combinations of two or more thereof.

The particle diameter of the rubber particles is not particularly limited, and it is preferably 0.01 to 10 μm, and particularly preferably 0.05 to 5 μm. When the rubber particles have a particle diameter of 0.01 μm or more, an increase in viscosity can be suppressed. When the rubber particles have a particle diameter of 10 μm or less, it is possible to obtain an electrically conductive resin adhesive agent from which a cured product having excellent conductivity is obtained.

The content of the rubber particles is not particularly limited, and is preferably 0.01 to 20 parts by mass, and more preferably 0.05 to 10 parts by mass, with respect to 100 parts by mass of the component (A). When the content of the rubber particles is 0.01 parts by mass or more with respect to 100 parts by mass of the component (A), it is possible to obtain an electrically conductive resin adhesive agent from which a cured product having superior conductivity is obtained. When the content of the rubber particles is 20 parts by mass or less with respect to 100 parts by mass of the component (A), it is possible to obtain an electrically conductive resin adhesive agent having excellent workability. In the case where two or more types of component (A) are used in combination, the amount of the component (A) refers to their total amount. In the case where two or more types of rubber particles are used in combination, the amount of the rubber particle refers to their total amount.

### (Storage Stabilizer)

The electrically conductive resin adhesive agent according to the present aspect may further contain a storage stabilizer, or may not further contain a storage stabilizer. The storage stabilizer is not particularly limited as long as it improves storage stability. As the storage stabilizer, a boric acid ester compound, phosphoric acid, an alkyl phosphate ester, p-toluenesulfonic acid, methyl p-toluenesulfonate, and the like may be compounded. Examples of the boric acid ester compound include trimethyl borate, triethyl borate, tri-n-propyl borate, triisopropyl borate, tributyl borate, trihexyl borate, tri-n-octyl borate, tris(2-ethylhexyloxy)borane, triphenyl borate, and trimethoxyboroxine. Examples of a commercially available product of the boric acid ester compound include, but are not particularly limited to, “Cureduct (registered trademark) L-07N” (manufactured by Shikoku Chemicals Corporation). As the alkyl phosphate ester, for example, trimethyl phosphate, tributyl phosphate, and the like can be used, but the alkyl phosphate ester are not limited to these. A storage stabilizer may be used singly, or a plurality of them may be mixed for use. In consideration of storage stability, it is preferable that the storage stabilizer is phosphoric acid, tributyl borate, trimethoxyboroxine, and/or methyl p-toluenesulfonate.

### (Radical Polymerizable Compound)

The electrically conductive resin adhesive agent according to the present aspect may further contain a radical polymerizable compound, or may not further contain a radical polymerizable compound. In the present specification, the radical polymerizable compound excludes all of the compound having a glycidyl group, the polyfunctional vinyl ether having a cyclic structure, and the silane coupling agent. That is, in the present specification, the radical polymerizable compound refers to a compound having radical polymerizability that is none of the compound having a glycidyl group, the polyfunctional vinyl ether having a cyclic structure, and the silane coupling agent. In the present specification, a silane coupling agent having a radical polymerizable functional group is treated as the silane coupling agent described above, and is not treated as the radical polymerizable compound. In the present specification, a polyfunctional vinyl ether having a cyclic structure is treated as the component (B), and is not treated as the radical polymerizable compound. Although the reason is unknown, when the electrically conductive resin adhesive agent contains a radical polymerizable compound, the curability of the electrically conductive resin adhesive agent and/or the flexibility of the cured product are improved. Examples of the radical polymerizable compound include, but are not particularly limited to, a monofunctional (meth)acrylic monomer, a polyfunctional (meth)acrylic monomer, a (meth)acrylic oligomer, and a cyclized polymerizable monomer. These may be used singly or in combinations of two or more thereof.

### [Organic Solvent]

The electrically conductive resin adhesive agent according to the present aspect may further contain an organic solvent, or may not further contain an organic solvent. The term “organic solvent” herein refers to a compound that is generally used as an organic solvent and is a component other than the components (A) to (D) and the optional components listed above. That is, even when the components (A) to (D) and the optional components listed above are liquid compounds, these liquid compounds are treated as substances different from the organic solvent. It is preferable that the electrically conductive resin adhesive agent according to one embodiment is substantially free from the organic solvent, and more preferably free from the organic solvent. The expression “the electrically conductive resin adhesive agent being substantially free from the organic solvent” herein means that the content of the organic solvent is 1% by mass or less with respect to the entire electrically conductive resin adhesive agent. The expression “the electrically conductive resin adhesive agent being free from the organic solvent” herein means that the content of the organic solvent is 0% by mass with respect to the entire electrically conductive resin adhesive agent. The content of the organic solvent is not particularly limited, and it is preferably 1% by mass or less, more preferably 0.5% by mass or less, still more preferably 0.1% by mass or less, and particularly preferably 0% by mass, with respect to the entire electrically conductive resin adhesive agent. When the electrically conductive resin adhesive agent contains the organic solvent, depending on the compositional features of the electrically conductive resin adhesive agent, deterioration of storage stability due to dissolution of the component (D) by the organic solvent and/or separation of the organic solvent from the electrically conductive resin adhesive agent may occur, which may affect physical properties. On the other hand, when the content of the organic solvent is 1% by mass or less with respect to the entire electrically conductive resin adhesive agent, there is a tendency that the storage stability is improved and/or that separation from the electrically conductive resin adhesive agent is less likely to occur. In one embodiment, the content of the organic solvent may be more than 1% by mass with respect to the entire electrically conductive resin adhesive agent. In the case where two or more types of organic solvents are used in combination, the amount of the organic solvent refers to their total amount.

Examples of the organic solvent include, but are not particularly limited to, an aromatic organic solvent such as toluene and xylene; an aliphatic organic solvent such as n-hexane; an alicyclic organic solvent such as cyclohexane, methylcyclohexane, and ethylcyclohexane; a ketone-based organic solvent such as acetone and methyl ethyl ketone; an alcohol-based organic solvent such as methanol and ethanol; an ester-based organic solvent such as ethyl acetate and butyl acetate; a propylene glycol ether-based organic solvent such as propylene glycol methyl ether, propylene glycol ethyl ether, and propylene glycol t-butyl ether; and the like.

### [Method for Producing Electrically Conductive Resin Adhesive Agent]

The method for producing the electrically conductive resin adhesive agent according to the present aspect is not particularly limited, and examples thereof include a method including mixing the components (A) to (D). In one embodiment, the method for producing the electrically conductive resin adhesive agent is preferably a method that includes mixing the components (A) to (D), does not include adding the monofunctional reactive diluent, and does not include adding the organic solvent. In one embodiment, the method for producing the electrically conductive resin adhesive agent is more preferably a method that includes mixing the components (A) to (D), and does not include adding components other than the components (A) to (D). If necessary, the method may include further mixing the components (A) to (D) with at least one component selected from the group consisting of the optional components and the organic solvent.

The mixing order, mixing method, and mixing conditions for the components are not particularly limited. As for the mixing order, it is preferable to obtain a mixture through mixing the components (A) to (C), and then to mix the obtained mixture with the component (D). Therefore, in one embodiment, the method for producing the electrically conductive resin adhesive agent is preferably a method that includes mixing the components (A) to (C) to obtain a mixture and mixing the obtained mixture with the component (D). In one embodiment, the method for producing the electrically conductive resin adhesive agent is preferably a method that includes mixing the components (A) to (C) to obtain a mixture and mixing the obtained mixture with the component (D), does not include adding the monofunctional reactive diluent, and does not include adding the organic solvent. In one embodiment, the method for producing the electrically conductive resin adhesive agent is still more preferably a method that includes mixing the components (A) to (C) to obtain a mixture and mixing the obtained mixture with the component (D), and does not include adding components other than the components (A) to (D).

### [Method for Curing Electrically Conductive Resin Adhesive Agent and Cured Product of Electrically Conductive Resin Adhesive Agent]

By curing the electrically conductive resin adhesive agent according to the present aspect, a cured product can be obtained. The electrically conductive resin adhesive agent according to one embodiment can be cured by heating for a short time (shorter than 10 minutes). Among the curing conditions of the electrically conductive resin adhesive agent, the heating temperature (heating and curing temperature) is not particularly limited, and for example, from the viewpoint of causing less damage to members of the adherend, it is preferably a temperature of 100° C. to 180° C., and more preferably a temperature of 130° C. to 150° C. Among the curing conditions of the electrically conductive resin adhesive agent, the heating and curing time is not particularly limited, and for example, from the viewpoint of production efficiency in a method for producing a cured product using the electrically conductive resin adhesive agent or a produced material containing the same, it is preferably 1 second to 10 minutes, more preferably 1 second to 5 minutes, and still more preferably 3 seconds to 3 minutes. In addition, after the heating step under the above curing conditions, an additional heating step at a low temperature (lower than 100° C.) may be further provided. By providing the additional heating step, it is possible to obtain a cured product having superior adhesive force and/or electrical conductivity. The temperature conditions of the additional heating step (heating temperature, heating and curing temperature) are not particularly limited, and are preferably a temperature of 45° C. to lower than 100° C., and more preferably a temperature of 50° C. to 95° C. The heating and curing time of the additional heating step is not particularly limited, and in the case where the heating and curing temperature is 45° C. to lower than 100° C., it is preferably 10 minutes to 3 hours, and more preferably 30 minutes to 2 hours. A cured product obtained by curing the electrically conductive resin adhesive agent according to the present aspect is also part of embodiments of the present invention. Therefore, another aspect of the present invention may be said to relate to a cured product formed by curing the electrically conductive resin adhesive agent according to the above aspect (a cured product obtained by curing the electrically conductive resin adhesive agent according to the above aspect). The details of the electrically conductive resin adhesive agent according to the above aspect for forming a cured product according to such an aspect are as described above.

In one embodiment, as for the electrical conductivity of a cured product formed by curing the electrically conductive resin adhesive agent by heating at 130° C. for 3 minutes (a cured product formed by curing the electrically conductive resin adhesive agent by 130° C.×3 minutes), a smaller resistance value is preferable. In one embodiment, the electrical conductivity (resistance value) of a cured product formed by curing the electrically conductive resin adhesive agent by 130° C.×3 minutes is preferably 1.0Ω or less, more preferably 0.5Ω or less, still more preferably 0.3Ω or less, and particularly preferably 0.2Ω or less (lower limit: 0Ω).

Therefore, by curing the electrically conductive resin adhesive agent according to one embodiment by heating at 130° C. for 3 minutes, it is possible to obtain preferably a cured product having an electrical conductivity of 0.3Ω or less, more preferably a cured product having an electrical conductivity of 1.0Ω or less, still more preferably a cured product having an electrical conductivity of 0.5Ω or less, even more preferably a cured product having an electrical conductivity of 0.3Ω or less, and particularly preferably a cured product having an electrical conductivity of 0.2Ω or less. It should be noted that the lower limit of electrical conductivity is 0Ω.

In one embodiment, as for the electrical conductivity of a cured product that has been cured by heating at 130° C. for 3 minutes, followed by heating at 80° C. for 60 minutes (a cured product formed by curing the electrically conductive resin adhesive agent by 130° C.×3 minutes+80° C.×60 minutes), a smaller resistance value is preferable. In one embodiment, the electrical conductivity (resistance value) of a cured product formed by curing the electrically conductive resin adhesive agent by 130° C.×3 minutes+80° C.×60 minutes is preferably 1.0Ω or less, more preferably 0.5Ω or less, still more preferably 0.3Ω or less, even more preferably 0.2Ω or less, and particularly preferably 0.1Ω or less (lower limit: 0Ω). Therefore, in one embodiment, by curing the electrically conductive resin adhesive agent by 130° C.×3 minutes+80° C.×60 minutes, it is possible to obtain preferably a cured product having an electrical conductivity of 1.0Ω or less, more preferably a cured product having an electrical conductivity of 0.5Ω or less, still more preferably a cured product having an electrical conductivity of 0.3Ω or less, even more preferably a cured product having an electrical conductivity of 0.2Ω or less, and particularly preferably a cured product having an electrical conductivity of 0.1Ω or less. It should be noted that the lower limit of electrical conductivity is 0Ω.

In the present specification, the resistance value of a cured product of the electrically conductive resin adhesive agent is a value measured and calculated by the following method. First, for a test piece including an electroless nickel-plated sheet and five cured products arranged on the surface of the electroless nickel-plated sheet at predetermined intervals, the resistance values of four adjacent pairs of the cured products are each measured by contacting needle electrodes of a dual-display multimeter to the adjacent cured products. Then, the average value of these resistance values is taken as the resistance value of the cured product (the resistance value of the cured product of the electrically conductive resin adhesive agent). Details of the method for measuring the electrical conductivity of the electrically conductive resin adhesive agent will be described in the Examples.

In one embodiment, as for the adhesive strength of a cured product formed by curing the electrically conductive resin adhesive agent by heating at 130° C. for 3 minutes (a cured product formed by curing the electrically conductive resin adhesive agent by 130° C.×3 minutes), a larger value is preferable. In one embodiment, the adhesive strength of a cured product formed by curing the electrically conductive resin adhesive agent by 130° C.×3 minutes is preferably 10 MPa or more, more preferably 12 MPa or more, still more preferably 14 MPa or more, even more preferably 18 MPa or more, yet more preferably more than 19 MPa, further preferably 24 MPa or more, and particularly preferably 28 MPa or more. Therefore, in one embodiment, by curing the electrically conductive resin adhesive agent by 130° C.×3 minutes, it is possible to obtain preferably a cured product having an adhesive strength of 10 MPa or more, more preferably a cured product having an adhesive strength of 12 MPa or more, still more preferably a cured product having an adhesive strength of 14 MPa or more, even more preferably a cured product having an adhesive strength of 18 MPa or more, yet more preferably a cured product having an adhesive strength of more than 19 MPa, further preferably a cured product having an adhesive strength of 24 MPa or more, and particularly preferably a cured product having an adhesive strength of 28 MPa or more.

In one embodiment, as for the adhesive strength of a cured product that has been cured by heating at 130° C. for 3 minutes, followed by heating at 80° C. for 60 minutes (a cured product formed by curing the electrically conductive resin adhesive agent by 130° C.×3 minutes+80° C.×60 minutes), a larger value is preferable. In one embodiment, the adhesive strength of a cured product formed by curing the electrically conductive resin adhesive agent by 130° C.×3 minutes+80° C.×60 minutes is preferably 10 MPa or more, more preferably 12 MPa or more, still more preferably 14 MPa or more, even more preferably 18 MPa or more, yet more preferably more than 19 MPa, further preferably 24 MPa or more, and particularly preferably 28 MPa or more. Therefore, in one embodiment, by curing the electrically conductive resin adhesive agent by 130° C.×3 minutes+80° C.×60 minutes, it is possible to obtain preferably a cured product having an adhesive strength of 10 MPa or more, more preferably a cured product having an adhesive strength of 12 MPa or more, still more preferably a cured product having an adhesive strength of 14 MPa or more, even more preferably a cured product having an adhesive strength of 18 MPa or more, yet more preferably a cured product having an adhesive strength of more than 19 MPa, further preferably a cured product having an adhesive strength of 24 MPa or more, and particularly preferably a cured product having an adhesive strength of 28 MPa or more.

The adhesive strength of a cured product of the electrically conductive resin adhesive agent is a value measured and calculated by the following method. First, for a test piece formed by bonding an electroless nickel-plated sheet and a ceramic chip (material: alumina, 2φ (2 mm diameter)×1 mm) with the cured product, the electroless nickel-plated sheet is fixed, and a digital force gauge with a contactor is moved at 50 mm/min, thereby allowing the contactor to press the chip in a direction perpendicular to the long side of the test piece to measure the maximum strength. Then, through conversion based on the bonded area, the adhesive strength is calculated from the maximum strength value. The average value of the adhesive strengths of five test pieces measured by the above method is taken as the adhesive strength of the cured product (the adhesive strength of the cured product of the electrically conductive resin adhesive agent). Details of the method for measuring the adhesive strength of the electrically conductive resin adhesive agent will be described in the Examples.

### <Applications of Electrically Conductive Resin Adhesive Agent and Cured Product Thereof>

Applications of the electrically conductive resin adhesive agent according to the above aspect are not particularly limited. Since the electrically conductive resin adhesive agent according to the above aspect can be cured by heating for a short time, it can be used for members employing materials easily affected by heat (for example, plastics and the like). Therefore, the electrically conductive resin adhesive agent according to a preferred embodiment can be used for, although not particularly limited, applications where materials easily affected by heat (for example, plastics and the like), to which heat cannot be applied for a long time, are bonded to such materials easily affected by heat or to materials other than such materials easily affected by heat. Specific examples of the member employing a material easily affected by heat (for example, a plastic and the like) include, but are not particularly limited to, a liquid crystal display device, an organic EL device, a solar cell device, a camera module, a flexible printed circuit board, a wearable, and a battery pack.

The electrically conductive resin adhesive agent according to the above aspect can be used for electronic components and the like where conductivity is required. Among these, from the viewpoint that the cured product exhibits excellent conductivity and adhesive force, the electrically conductive resin adhesive agent according to one embodiment is preferably used for electronic components including an adherend having nickel as the outermost surface, which is inferior in conductivity. In the electronic component including an adherend having nickel as the outermost surface, which is inferior in conductivity, it is preferable that at least one adherend to which a cured product formed by curing the electrically conductive resin adhesive agent according to one embodiment is bonded contains an adherend having nickel as the outermost surface, which is inferior in conductivity. In the electronic component including an adherend having nickel as the outermost surface, which is inferior in conductivity, it is more preferable that the adherend having nickel as the outermost surface and a ceramic chip are bonded by a cured product formed by curing the electrically conductive resin adhesive agent according to one embodiment. The adherend whose outermost surface is nickel (the adherend having nickel as the outermost surface) is not particularly limited, and it may be an adherend composed of nickel alone; however, examples thereof mainly include one subjected to nickel plating (adherends formed by performing nickel plating). Examples of the adherend formed by performing nickel plating include, but are not particularly limited to, one formed by performing electrolytic plating on a SPCC (cold rolled steel sheet), a stainless steel member, or a copper member (for example, an electrolytic nickel-plated sheet), and one formed by performing electroless plating on a SPCC (cold rolled steel sheet), a stainless steel member, or a copper member (for example, an electroless nickel-plated sheet). Specific examples of the adherend formed by performing nickel plating include an electric wire and a printed circuit board.

Applications of the cured product according to the above aspect are not particularly limited, and examples thereof include applications that are the same as the applications of the electrically conductive resin adhesive agent described above.

The embodiments of the present invention are described in detail above, but are given for explanatory and illustrative purposes only, and are not limited. The scope of the present invention should be obviously construed on the basis of the attached claims.

### EXAMPLES

Next, the present invention will be described in further detail with reference to the Examples, but the present invention is not limited only to these Examples. Also, in the following, unless otherwise specified, the tests were conducted in an environment of a temperature of 25° C. and a relative humidity of 55% RH.

### Examples 1 to 4 and Comparative Examples 1 to 3

In order to prepare electrically conductive resin adhesive agents, the following components were provided. Hereinafter, the electrically conductive resin adhesive agents are also simply referred to as the compositions.

### <<Component (A): Epoxy Resin>>

EPICLON (registered trademark) EXA-835LV (a mixture of bifunctional bisphenol A type epoxy resin and bifunctional bisphenol F type epoxy resin, mixing mass ratio 50:50, manufactured by DIC Corporation)
Adeka Resin (registered trademark) EP-4000 (bifunctional polyoxyalkylene-modified bisphenol A type epoxy resin, manufactured by ADEKA Corporation)
jER (registered trademark) YX8000 (bifunctional hydrogenated bisphenol A type epoxy resin, manufactured by Mitsubishi Chemical Corporation)

### <<Component (B): Polyfunctional Vinyl Ether Having Cyclic Structure>>

CHDVE (cyclohexanedimethanol divinyl ether, manufactured by Nippon Carbide Industries Co., Inc.)
   <<Component (B′): Vinyl Ether Other than Component (B)>>
DEGDVE (diethylene glycol divinyl ether, manufactured by Nippon Carbide Industries Co., Inc.)
CHVE (cyclohexyl vinyl ether, manufactured by Nippon Carbide Industries Co., Inc.)

### <<Component (C): Electrically Conductive Particles>>

M27 (crystalline silver particles, plate-like, not surface-treated, average particle diameter: 4.5 μm, specific surface area: 1.0 m²/g, manufactured by Tokusen Kogyo Co., Ltd.)

### <<Component (D): Thermal Cationic Polymerization Initiator>>

K-PURE (registered trademark) CXC-1821 (salt composed of tetrakis(pentafluorophenyl)borate anion and quaternary ammonium cation, manufactured by King Industries, Inc.)

### <<Optional Component>>

CARDURA E10P (monofunctional reactive diluent, neodecanoic acid glycidyl ester, manufactured by MOMENTIVE SPECIALTY CHEMICALS INC.)

The method for producing the compositions according to Examples 1 to 4 and Comparative Examples 1 to 3 was as follows. The component (A), component (B) (or component (B′)) and component (C), and further the optional component as necessary, were weighed, and these components were stirred using a planetary mixer for 30 minutes. Subsequently, the component (D) was weighed and added, and the mixture was further stirred while performing vacuum defoaming for 30 minutes using the planetary mixer, thereby obtaining the electrically conductive resin adhesive agents. The obtained electrically conductive resin adhesive agents were all liquid at 25° C. The detailed preparation amounts are as shown in Table 1. The numerical values of the amount of each component and the total amount in Table 1 are all expressed in parts by mass.

### <Electrical Conductivity Measurement>

In masking tape with a width of 10 mm and a thickness of 100 μm, five holes with a diameter of 5 mm were punched along the length direction at 10 mm intervals. The masking tape with the holes was pasted to an electroless nickel-plated sheet of 25 mm in width, 100 mm in length, and 1.6 mm in thickness. The composition was applied onto the electroless nickel-plated sheet to which the masking tape with the holes had been pasted, using a squeegee. Care was taken to prevent bubbles from being entrapped in the composition during the application using the squeegee. Next, the masking tape with the holes was peeled off to obtain a test piece. The test piece was allowed to stand still on a hot plate set to 130° C. and left for 3 minutes, after which the test piece was removed from the hot plate. After the temperature of the test piece had decreased to 25° C., needle electrodes of a dual-display multimeter (DL-2050 manufactured by Kenwood Corporation) were brought into contact with adjacent cured products of the composition to measure the resistance. The resistance values of four adjacent pairs of the cured products were each measured, and the average value of the obtained resistance values was defined as the “Conductivity at 130° C.×3 minutes (Ω)”.

Furthermore, the test piece on which heating had been carried out at 130° C. for 3 minutes as described above was heated in a hot air drying furnace at 80° C. for 60 minutes. After removing the test piece from the hot air drying furnace and allowing the temperature of the test piece to decrease to 25° C., in the same manner as in the above test method, the resistance values was measured by bringing needle electrodes of a dual-display multimeter (DL-2050 manufactured by Kenwood Corporation) into contact with adjacent cured products of the composition. The resistance values of four adjacent pairs of the cured products were each measured, and the average of the obtained resistance values was defined as the “Conductivity at 130° C.×3 minutes+80° C.×60 minutes (Ω)”.

In the present evaluation, for both “Conductivity at 130° C.×3 minutes (Ω)” and “Conductivity at 130° C.×3 minutes+80° C.×60 minutes (Ω)”, a conductivity (resistance value) of 1.0Ω or less was evaluated to be preferable, 0.5Ω or less was evaluated to be more preferable, and 0.3Ω or less was evaluated to be still more preferable. Additionally, the test result labeled as “Insulation” indicates that the resistance value exceeded the measurement limit of the dual-display multimeter.

### <Adhesive Strength Measurement>

Masking tape was pasted to an electroless nickel-plated sheet of 1.6 mm in thickness, 25 mm in width, and 100 mm in length so that the location for applying the composition was 5 mm in width and 50 μm in thickness. The composition was applied using a squeegee to form a uniform coating film, after which the masking tape was peeled off. A ceramic chip (material: alumina) of 2φ (diameter 2 mm)×1 mm was dropped vertically from 1 cm above the coating film so that the 2φ face served as the bonding surface, thereby fabricating a test piece (n=5; that is, five test pieces were fabricated). The test piece was allowed to stand still on a hot plate set to 130° C. and left for 3 minutes, after which the test piece was removed from the hot plate. After allowing the temperature of the test piece to decrease to 25° C., the electroless nickel-plated sheet was fixed, and a digital force gauge with a contactor (FGP-20 manufactured by Nidec Drive Technology Corporation) was moved at 50 mm/min, thereby allowing the contactor to press the chip in a direction perpendicular to the long side of the test piece to measure the “maximum strength (N)”. Through conversion based on the bonded area, the average value of n=5 was calculated, and the “Adhesive strength at 130° C.×3 minutes (MPa)” was calculated (that is, through conversion based on the bonded area, the adhesive strength of each test piece was calculated from the “maximum strength (N)”, and the average value of the adhesive strength in the five test pieces was calculated and defined as the “Adhesive Strength at 130° C.×3 minutes (MPa)”).

In addition, a test piece was separately fabricated by curing the composition by heating at 130° C. for 3 minutes in the same manner as described above, and the fabricated test piece was heated in a hot air drying furnace at 80° C. for 60 minutes. After removing the test piece from the hot air drying furnace and allowing the temperature of the test piece to decrease to 25° C., in the same manner as in the above test method, the electroless nickel-plated sheet was fixed, and a digital force gauge with a contactor (FGP-20 manufactured by Nidec Drive Technology Corporation) was moved at 50 mm/min, thereby allowing the contactor to press the chip in a direction perpendicular to the long side of the test piece to measure the “maximum strength (N)”. Through conversion based on the bonded area, the average value of n=5 was calculated and defined as the “Adhesive strength at 130° C.×3 minutes+80° C.×60 minutes (MPa)” (that is, through conversion based on the bonded area, the adhesive strength of each test piece was calculated from the “maximum strength (N)”, and the average value of the adhesive strength in the five test pieces was calculated and defined as the “Adhesive Strength at 130° C.×3 minutes+80° C.×60 minutes (MPa)”).

In the present evaluation, in order to prevent the adherend from detaching, it is preferable that both the “Adhesive strength at 130° C.×3 minutes (MPa)” and the “Adhesive strength at 130° C.×3 minutes+80° C.×60 minutes (MPa)” are 10 MPa or more.

The results of the electrical conductivity measurement and adhesive strength measurement are shown in Table 1. It should be noted that blank cells in Table 1 indicate that the component is not contained.

TABLE 1

| | | Ex- | Ex- | Ex- | Ex- | | | |
|---|---|---|---|---|---|---|---|---|
| | | am- | am- | am- | am- | Com- | Com- | Com- |
| | | ple | ple | ple | ple | parative | parative | parative |
| | | 1 | 2 | 3 | 4 | Example 1 | Example 2 | Example 3 |
| Component | EXA-835LV | 70 | | | 35 | 70 | 70 | 70 |
| (A) | EP-4000 | | 70 | | | | | |
| | YX8000 | | | 70 | 35 | | | |
| Component | CHDVE | 30 | 30 | 30 | 30 | | | |
| (B) | | | | | | | | |
| Component | DEGDVE | | | | | 30 | | |
| (B′) | CHVE | | | | | | 30 | |
| Component | M27 | 350 | 350 | 350 | 350 | 350 | 350 | 350 |
| (C) | | | | | | | | |
| Component | CXC-1821 | 10 | 10 | 10 | 10 | 10 | 10 | 10 |
| (D) | | | | | | | | |
| Optional | E10P | | | | | | | 30 |
| component | | | | | | | | |

| | | | | | | | |
|---|---|---|---|---|---|---|---|
| Total | 460 | 460 | 460 | 460 | 460 | 460 | 460 |
| Electrical conductivity at | 0.2 | 0.2 | 0.2 | 0.2 | 3.0 | 30.0 | Insulation |
| 130° C. × 3 minutes (Ω) | | | | | | | |
| Electrical conductivity at | 0.1 | 0.1 | 0.2 | 0.2 | 2.0 | 15.0 | Insulation |
| 130° C. × 3 minutes + 80° C. × | | | | | | | |
| 60 minutes ((2) | | | | | | | |
| Adhesive strength at 130° C. × | 13 | 15 | 30 | 20 | 4 | 4 | 0 |
| 3 minutes (MPa) | | | | | | | |
| Adhesive strength at 130° C. × | 19 | 20 | 29 | 25 | 12 | 15 | 2 |
| 3 minutes + 80° C. × 60 | | | | | | | |
| minutes (MPa) | | | | | | | |

Examples 1 to 4 are each a composition containing the components (A) to (D), which differs in the structure of the component (A), but were all confirmed to exhibit excellent conductivity of the cured product and adhesive force of the cured product. In particular, Examples 1 and 2, which include only bisphenol type epoxy resin as the component (A), were each confirmed to have excellent electrical conductivity of the cured product. Example 3, which includes only hydrogenated bisphenol A type epoxy resin as the component (A), was confirmed to have excellent adhesive strength of the cured product. Example 4 is a composition containing bisphenol type epoxy resin and hydrogenated bisphenol type epoxy resin as the component (A), and yielded a cured product with a good balance between electrical conductivity and adhesive strength. In all cases, even with curing in a short time such as heating at 130° C. for 3 minutes, the obtained cured products demonstrated sufficient electrical conductivity, and the obtained cured products also demonstrated sufficient adhesive strength.

On the other hand, Comparative Examples 1 and 2 are compositions containing DEGDVE and CHVE, respectively, as the component (B′) instead of the component (B), but were confirmed to be inferior in electrical conductivity and adhesive strength of the cured product. Comparative Example 3 is a composition containing neither the component (B) nor (B′), but instead containing the optional component E10P, and was found to be inferior in curability, as well as conductivity and adhesive strength of the cured product.

### INDUSTRIAL APPLICABILITY

The electrically conductive resin adhesive agent according to one aspect of the present invention exhibits excellent conductivity of the cured product and adhesive strength of the cured product through curing in a short time. For this reason, the electrically conductive resin adhesive agent according to one aspect of the present invention and the cured product according to another aspect of the present invention are useful in conductive and adhesive applications for electrical and electronic components that have been miniaturized in recent years, and are particularly capable of lowering the resistance value of the cured product against metals, especially such as nickel, which tend to have poor conductivity. Due to these characteristics, the electrically conductive resin adhesive agent according to one aspect of the present invention and the cured product according to another aspect of the present invention can be used for assembling various electrical and electronic components, and the like, and have the potential to be developed in wide applications.

The present application is based on the Japanese patent application No. 2023-98857 filed on Jun. 16, 2023, and the disclosed content thereof is incorporated herein by reference in its entirety.

1. An electrically conductive resin adhesive agent comprising the following components (A) to (D):
component (A): an epoxy resin having two or more glycidyl groups;
component (B): a polyfunctional vinyl ether having a cyclic structure, which is not an epoxy resin having two or more glycidyl groups;
component (C): electrically conductive particles; and
component (D): a thermal cationic polymerization initiator.

2. The electrically conductive resin adhesive agent according to claim 1, wherein the component (A) comprises a bisphenol type epoxy resin.

3. The electrically conductive resin adhesive agent according to claim 1, wherein the component (A) comprises a hydrogenated bisphenol type epoxy resin.

4. The electrically conductive resin adhesive agent according to claim 1, wherein the component (B) is a polyfunctional vinyl ether having an alicyclic structure.

5. The electrically conductive resin adhesive agent according to claim 1, wherein the component (C) comprises crystalline electrically conductive particles.

6. The electrically conductive resin adhesive agent according to claim 1, wherein a cationic species of the component (D) is a quaternary ammonium cation.

7. The electrically conductive resin adhesive agent according to claim 1, wherein the component (B) is cyclohexanedimethanol divinyl ether.

8. The electrically conductive resin adhesive agent according to claim 1, wherein a cured product that has been cured by heating at 130° C. for 3 minutes has an electrical conductivity of 0.3Ω or less.

9. A cured product formed by curing the electrically conductive resin adhesive agent according to claim 1.
